(19) United States
(12) Patent Application Publication
(10) Pub. No.: US 2025/0272720 A1
(43) Pub. Date: Aug. 28, 2025

(54) PROCESSING PROPERTY EMBEDDINGS TO LEARN RANKINGS OF COMPARABLE PROPERTIES SYSTEMS AND METHODS

(71) Applicant: MFTB Holdco, Inc., Seattle, WA (US)

(72) Inventor: Reid Johnson, Seattle, WA (US)

(21) Appl. No.: 17/581,466

(22) Filed: Jan. 21, 2022

(51) Int. Cl. G06Q 30/02; G06N 3/08; G06Q 50/16

(52) U.S. Cl. CPC G06Q 30/0278; G06N 3/08; G06Q 50/16

(57) ABSTRACT

Comps processing systems and methods for processing embeddings of properties and candidate comparable properties thereof to learn an implicit ranking of the candidate comparable properties are disclosed. The comps processing system uses embeddings, predicted values, and actual values of particular properties and candidate comparable properties thereof to train an implicit comparable-ranking model to produce comparable-adjusted predicted values and intermediate outputs. The comps processing system can then extract the intermediate outputs from the trained implicit comparable-ranking model, when applied to subject properties. The intermediate outputs can include compatibility probabilities, which represent a degree of compatibility between the subject property and a candidate comparable property thereof. Accordingly, the comps processing system can learn the similarities between a subject property and candidate comparable properties thereof when learning to value the subject property. The compatibility probabilities can be used to rank the candidate comparable properties and select those most similar to the subject property.

### BACKGROUND

In many roles, it can be useful to be able to accurately determine the value of residential real estate properties (“homes”). A variety of conventional approaches exist for valuing properties. For a property that was very recently sold, one approach is attributing its sale price as its value. Another widely used conventional approach to valuing properties is appraisal, where a professional appraiser determines a value for a property by comparing some of its attributes to the attributes of similar nearby properties that have recently sold (“comparable properties,” “comps,” or “comparables”). The appraiser arrives at an appraised value by subjectively adjusting the sale prices of the comps to reflect differences between the attributes of the comps and the attributes of the property being appraised, then aggregating these adjusted sale prices, such as by determining their mean. A further widely used conventional approach to valuing houses involves statistical methods. Historical property sale transactions can be used together with attributes (e.g., location, age, size, construction, style, condition) of the sold properties to construct a model capable of predicting the value of an arbitrarily selected property based upon its attributes. This model can then be applied to the attributes of any property in order to estimate the value of this property.

### BRIEF DESCRIPTION OF THE DRAWINGS

FIG. 1 is a block diagram showing some of the components typically incorporated in at least some of the computer systems and other devices on which the disclosed system operates in accordance with some implementations of the present technology.

FIG. 2 is a system diagram illustrating an example of a computing environment in which the disclosed system operates in some implementations of the present technology.

FIG. 3 is a block diagram illustrating components of a comps processing system in accordance with some implementations of the present technology.

FIG. 4 is a flow diagram illustrating a process of generating embeddings and predicted values of properties in accordance with some implementations of the present technology.

FIG. 5 is a flow diagram illustrating a process of training an implicit comparable-ranking model in accordance with some implementations of the present technology.

FIG. 6 is a flow diagram illustrating a process of implicitly ranking comparable properties in accordance with some implementations of the present technology.

FIG. 7 is a conceptual diagram illustrating an example of an embedding of a property in accordance with some implementations of the present technology.

FIG. 8 is a conceptual diagram illustrating an example of an implicit comparable-ranking model in accordance with some implementations of the present technology.

FIG. 9 is a conceptual diagram illustrating an example of the comps processing system learning an implicit ranking of candidate comparable properties in accordance with some implementations of the present technology.

In the drawings, some components and/or operations can be separated into different blocks or combined into a single block for discussion of some of the implementations of the present technology. Moreover, while the technology is amenable to various modifications and alternative forms, specific implementations have been shown by way of example in the drawings and are described in detail below. The intention, however, is not to limit the technology to the specific implementations described. On the contrary, the technology is intended to cover all modifications, equivalents, and alternatives falling within the scope of the technology as defined by the appended claims.

### DETAILED DESCRIPTION

A property valuation model is a type of statistical or machine learning-based model that can be used to generate a valuation or predicted price for a property (used herein as “predicted value”). A property valuation model attempts to generate a predicted value that is as close to what the actual value (e.g., actual sale price, list price, inferred sale price, adjusted sale price) of the property is (e.g., property has already been listed or sold) or may be (e.g., property is to be listed or sold). Even though existing methodologies involving property valuation models may use comparable properties to predict the value of a subject property, the process for determining and selecting such comparable properties to use (e.g., via heuristics, manual analysis) is separate from the process used to generate predicted values for subject properties based on the comparable properties. Traditionally, the comparable properties are already selected first, and then used in generating the predicted value of a subject property (e.g., generative approaches). As a result, the predicted value for a subject property has no bearing on the comparable properties selected. Such methodologies also require heavy amounts of computations, design ingenuity, processing power, and networking bandwidth. For instance, such methodologies have to evaluate large datasets of property transactions obtained from various remote data sources to not only determine a set of comparable properties for a subject property, but then use those comparable properties in another separate system to predict the value of the subject property.

Moreover, most existing property valuation models are a complete black-box and it is unclear how comparable properties that are used have an effect on the parameters of the model and the outputted predicted value. There is a lack of methodologies that can fully utilize the predictive capabilities of property valuation models to learn to select better comparable properties to use in predicting more accurate predicted values for subject properties. Notwithstanding, current systems and methods also require heavy amounts of computations, design ingenuity, processing power, and networking bandwidth to evaluate large datasets of property transactions obtained from various remote data sources just to determine a set of comparable properties for a subject property. Some systems utilize manual comparable market analysis of properties (e.g., an analyst finding the best comparable properties for a subject property), but a manual analysis performed is often biased, since is it largely based on the research of the analyst and their personal experience. A biased comparative market analysis can often lead to inaccurate valuations and less than ideal comparable properties selected.

To overcome these and other deficiencies of existing systems, the inventors have developed a system for processing embeddings of particular properties (e.g., subject properties) and candidate comparable properties thereof to learn an implicit ranking of the candidate comparable properties (the “comps processing system”). An embedding of a property can be a representation of the property in feature space (e.g., a vector of features of the property, a concatenation of vectorized features of a property, a layer of a neural network that learns to predict a value for a property). The comps processing system can extract or generate the embeddings of subject properties and the embeddings of candidate comparable properties thereof from property valuation models (e.g., generate a vector of raw property features values, extract learned vectors from property valuation models). In some instances, the property valuation models can be distributed across various different databases/data stores used to train and/or test the models. The comps processing system can apply to various property types, such as residential homes, commercial buildings, apartment buildings, commercial properties, land, rental properties, lots of land, uncompleted properties, and so on.

In various implementations, the comps processing system can use the embeddings, predicted values, and actual values of particular properties and candidate comparable properties thereof as model inputs for training an implicit comparable-ranking model. The implicit comparable-ranking model is a robust model that is predictively powerful. Not only is the comps processing system able to use the implicit comparable-ranking model to generate the most accurate predicted values for a subject property (i.e., predicted values close to the actual value, or predicted values that have low variance from the actual value), the system can generate intermediate outputs (e.g., outputs generated at hidden layers of a neural network) that help it select better comparable properties for the subject property to use in generating predicted values. The intermediate outputs can be compatibility probabilities generated for each candidate comparable property of a subject property as a measure of how similar the candidate is to the subject property. The implicit comparable-ranking model can generate compatibility probabilities using the embeddings of the subject property and candidate comparable properties thereof. The compatibility probabilities can provide an “implicit ranking” of the candidate comparable properties of the subject property, thereby allowing the comps processing system to select the comparable properties ranked with higher compatibility probabilities as better predictors of the value of the subject property.

By utilizing intermediate outputs of the implicit comparable-ranking model, the comps processing system is a feedback system that can (1) start with generating an initial predicted value of a subject property, (2) extract compatibility probabilities for candidate comparable properties of the subject property from the model, and then (3) improve/refine the predicted value of the subject property using the comparable properties with the greatest compatibility probabilities (e.g., weighing them more in predictions). Accordingly, the comps processing system is able to learn meaningful relationships between particular properties and candidate comparable properties thereof. The comps processing system thus improves the comparable property generation process by providing comparable properties for a subject property that are more interpretable, have actual values closer to the actual value of a subject property, and lead to improved and more accurate predicted values of properties.

Since the comps processing system selects comparable properties with values that are closer to the actual value of a subject property, the outputted predicted value is one that a seller or buyer would likely be willing to sell or buy the property for, respectively. Consequently, the comps processing system can reduce time, costs, and throwaway work by focusing on predicted values of properties closer to the actual value. For example, the comps processing system can reduce analyst time while still ensuring good accuracy for automated valuations. Such reductions can result in reduced usage of computing resources, storage space, and networking latency since valuations that ultimately are not confident and undesirable for buyers/sellers can be filtered out to not be further processed. The increased efficiencies can result in computing systems and networking devices being able to increase execution speed and delivery to entities seeking property valuations. Moreover, because the comps processing system can determine comparable properties implicitly and without the explicit generation of comparable properties, it can place less burden on having to train additional models that are computationally expensive and data hungry. Accordingly, fewer training examples need to be provided since the comps processing system can provide additional feedback as to how the similar candidate comparable properties are and select candidate comparable properties with greater similarity to a subject property. The comps processing system thus can allow both upstream and downstream systems to use fewer, less powerful, and less costly computing devices, along with fewer, less capacious, and less costly storage devices.

### Suitable Computing Environments

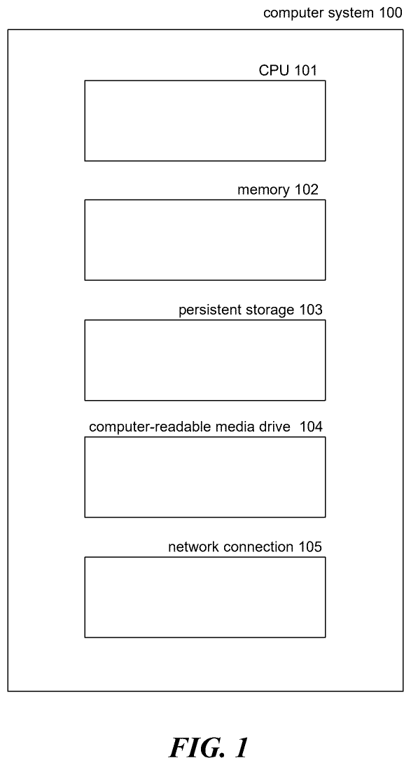

FIG. 1 is a block diagram showing some of the components typically incorporated in at least some of the computer systems and other devices on which the disclosed system operates. In various embodiments, these computer systems and other devices 100 can include server computer systems, desktop computer systems, laptop computer systems, netbooks, mobile phones, personal digital assistants, televisions, cameras, automobile computers, electronic media players, web services, mobile devices, watches, wearables, glasses, smartphones, tablets, smart displays, virtual reality devices, augmented reality devices, etc. In various embodiments, the computer systems and devices include zero or more of each of the following: a central processing unit (CPU) 101 for executing computer programs (e.g., a processor coupled to a memory that carries instructions executed by the process); a computer memory 102 for storing programs and data while they are being used, including the facility and associated data, an operating system including a kernel, and device drivers; a persistent storage device 103, such as a hard drive or flash drive for persistently storing programs and data; computer-readable media drives 104 (e.g., at least one non-transitory computer-readable medium executed by at least one data processor) that are tangible storage means that do not include a transitory, propagating signal, such as a floppy, CD-ROM, or DVD drive, for reading programs and data stored on a computer-readable medium; and a network connection 105 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. While computer systems configured as described above are typically used to support the operation of the facility, those skilled in the art will appreciate that the facility may be implemented using devices of various types and configurations, and having various components.

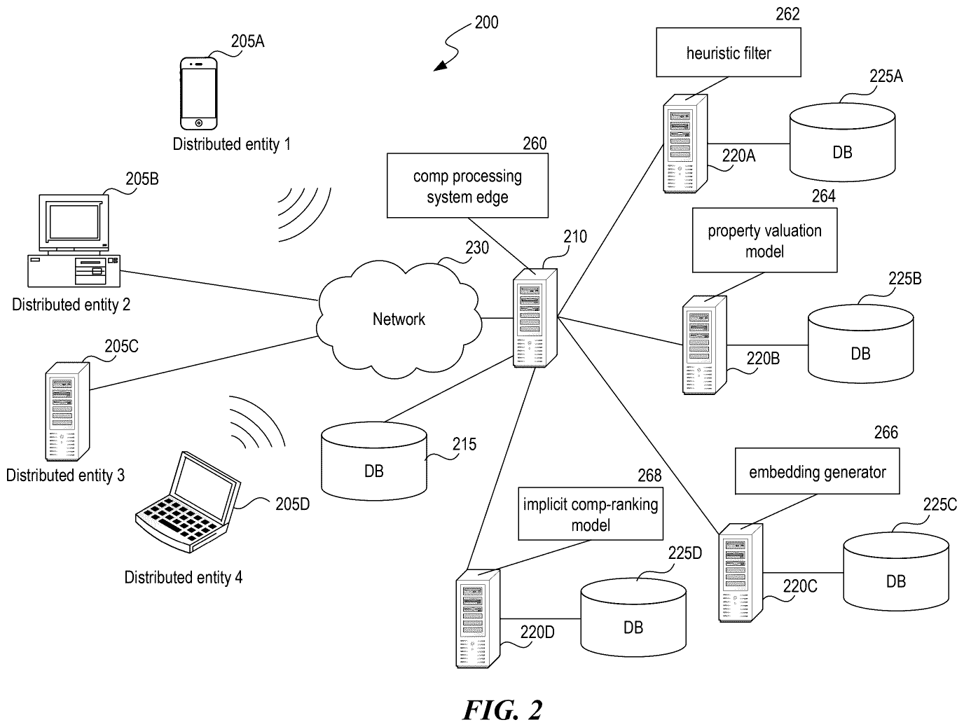

FIG. 2 is a system diagram illustrating an example of a computing environment in which the disclosed system operates in some embodiments. In some embodiments, environment 200 includes one or more client computing devices 205A-D, examples of which can host the system 100. For example, the computing devices 205A-D can comprise distributed entities 1-4, respectively. Client computing devices 205 operate in a networked environment using logical connections through network 230 to one or more remote computers, such as a server computing device.

In some embodiments, server 210 is an edge server which receives client requests and coordinates fulfillment of those requests through other servers, such as servers 220A-D. For example, the server 210 can comprise a comps processing system edge device 260 that receives client requests from the distributed entities 1-4 and coordinates fulfillment of those requests through servers 220A-D, which can comprise the comps processing system. The servers 220A-D can each comprise components of the comps processing system, such as a heuristic filter 262, a property valuation model 264, an embedding generator 266, and an implicit comparable-ranking model 268. In some embodiments, server computing devices 210 and 220 comprise computing systems, such as the system 100. Though each server computing device 210 and 220 is displayed logically as a single server, server computing devices can each be a distributed computing environment encompassing multiple computing devices located at the same or at geographically disparate physical locations. In some embodiments, each server 220 corresponds to a group of servers.

Client computing devices 205 and server computing devices 210 and 220 can each act as a server or client to other server or client devices. In some embodiments, servers (210, 220A-D) connect to a corresponding database (215, 225A-D). As discussed above, each server 220 can correspond to a group of servers, and each of these servers can share a database or can have its own database. Databases 215 and 225 warehouse (e.g., store) information such as property information, recent sales, property attributes, particular properties, subject properties, candidate comparable properties, comparable properties, property data, actual values of properties, predicted values of properties, property valuation models, model data, training data, test data, validation data, predicted errors, one or more machine learning models, synthetization/aggregation functions, predefined ranges, predefined thresholds, error thresholds, graphical representations, requests for valuations, market or location, time or seasons, types of properties, model performance, sale prices, listing prices, adjusted sale prices, inferred sale prices, embeddings, adjusted actual values of candidate comparable properties, weighted adjusted actual values of candidate comparable properties, implicit comparable-ranking models, comparable-adjusted predicted value, intermediate outputs, compatibility probabilities, raw values, one-hot encoded values, learned embeddings, individual vectors, concatenated vectors, raw numerical features log numerical features, geospatial values, time series, spatial maps, categorical values, neural network layers, computed differences/sums, loss values, model weights/parameters/nodes, and so on.

The one or more machine learning models can include supervised learning models, unsupervised learning models, semi-supervised learning models, self-supervised and/or reinforcement learning models. Examples of machine learning models suitable for use with the present technology include, but are not limited to: regression algorithms (e.g., ordinary least squares regression, linear regression, logistic regression, stepwise regression, multivariate adaptive regression splines, locally estimated scatterplot smoothing), instance-based algorithms (e.g., k-nearest neighbor, learning vector quantization, self-organizing map, locally weighted learning, support vector machines), regularization algorithms (e.g., ridge regression, least absolute shrinkage and selection operator, elastic net, least-angle regression), decision tree algorithms (e.g., classification and regression trees, Iterative Dichotomiser 3 (ID3), C4.5, C5.0, chi-squared automatic interaction detection, decision stump, M5, conditional decision trees), Bayesian algorithms (e.g., naïve Bayes, Gaussian naïve Bayes, multinomial naïve Bayes, averaged one-dependence estimators, Bayesian belief networks, Bayesian networks), clustering algorithms (e.g., k-means, k-medians, expectation maximization, hierarchical clustering), association rule learning algorithms (e.g., apriori algorithm, ECLAT algorithm), artificial neural networks (e.g., perceptron, multilayer perceptrons, back-propagation, stochastic gradient descent, Hopfield networks, radial basis function networks), deep learning algorithms (e.g., convolutional neural networks, recurrent neural networks, long short-term memory networks, stacked auto-encoders, deep Boltzmann machines, deep belief networks), dimensionality reduction algorithms (e.g., principle component analysis, principle component regression, partial least squares regression, Sammon mapping, multidimensional scaling, projection pursuit, discriminant analysis), time series forecasting algorithms (e.g., exponential smoothing, autoregressive models, autoregressive with exogenous input (ARX) models, autoregressive moving average (ARMA) models, autoregressive moving average with exogenous inputs (ARMAX) models, autoregressive integrated moving average (ARIMA) models, autoregressive conditional heteroskedasticity (ARCH) models), and ensemble algorithms (e.g., boosting, bootstrapped aggregation, AdaBoost, blending, stacking, gradient boosting machines, gradient boosted trees, random forest).

In various implementations, the one or more machine learning models can be trained on training data or a training set. The training data or training set can be created by generating pairs of features (e.g., feature vectors) and/or ground-truth labels/values based on any of the data stored in databases 215 and 225. During training, the machine learning models can be adjusted or modified to fit the models to the training data by, e.g., adjusting or modifying model parameters, such as weights and/or biases, so as to minimize some error measure (e.g., a difference between a predicted value and an actual/ground-truth value) over the training data. The error measure can be evaluated using one or more loss functions. Examples of loss functions that can be used include, but are not limited to, cross-entropy loss, log loss, hinge loss, mean square error, quadratic loss, L2 loss, mean absolute loss, L1 loss, Huber loss, pinball loss, smooth mean absolute error, log-cosh loss, or quantile loss. The trained machine learning models can then be applied to test data or validation data (e.g., holdout dataset) to generate predictions (e.g., predicted values or labels). The test data or validation data can also come from data that is stored in databases 215 and 225 (e.g., unlabeled data to generate predictions for). In some implementations, the machine learning models can be retrained to further modify/adjust model parameters and improve model performance. The machine learning models can be retrained on existing and/or new training data, training data, or validation data so as to fine-tune the model parameters to better fit the data and yield a different error measure over the data (e.g., further minimization of the error, or to increase the error to prevent overfitting). More specifically, the model can be further adjusted or modified (e.g., fine-tuned model parameters such as weights and/or biases) so as to alter the yielded error measure. Such retraining can be performed iteratively whenever it is determined that adjustments or modifications to the machine learning models are desirable.

Though databases 215 and 225 are displayed logically as single units, databases 215 and 225 can each be a distributed computing environment encompassing multiple computing devices, can be located within their corresponding server, or can be located at the same or at geographically disparate physical locations.

Network 230 can be a local area network (LAN) or a wide area network (WAN), but can also be other wired or wireless networks. In some embodiments, network 230 is the Internet or some other public or private network. Client computing devices 205 are connected to network 230 through a network interface, such as by wired or wireless communication. While the connections between server 210 and servers 220 are shown as separate connections, these connections can be any kind of local, wide area, wired, or wireless network, including network 230 or a separate public or private network.

### Comparables Processing System

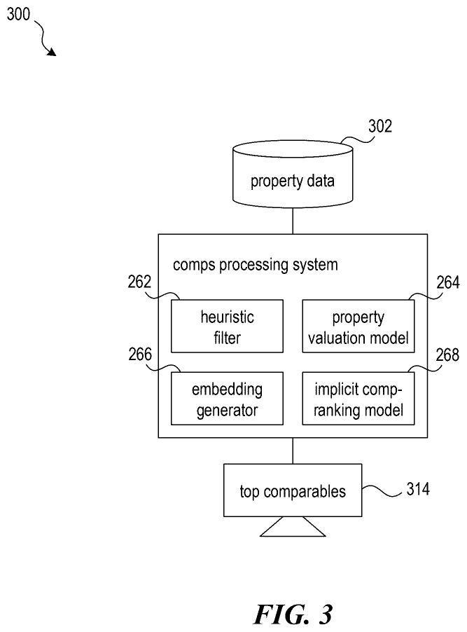

FIG. 3 is a block diagram illustrating components of a comps processing system 300 in accordance with some implementations of the present technology. The comps processing system 300 can include a property data store 302, a heuristic filter 262, a property valuation model 264, an embedding generator 266, and an implicit comparable-ranking model 268 described in relation to FIG. 2.

The property data store 302 can include property data, actual values of properties, and/or predicted values of properties. In some implementations, the property data store 302 can be remotely or locally connected to the comps processing system 300 via the network 230 described in relation to FIG. 2. In other implementations, the property data store 302 can be housed within the same computing device as that of the comps processing system 300. In various implementations, the databases 215 and 225 can include the property data store 302.

The property data can be possible aspects or features of properties or the training and/or testing methodologies used that can affect the predicted value of a subject property or the comparable properties determined therefor. The property data can specifically include property data records describing features of properties (used herein as “property features”) of various types and in various different geographic regions or markets. The properties can include any particular property, subject property, or comparable property thereof. Some of those properties may have been sold already (e.g., historical property transactions), some may currently be on the market (e.g., currently listed on the market), and some may not be for sale or on the market but can be valued. In some instances, each property data record can include a label for a property and the property features that describe the property.

Examples of property features can include, but are not limited to, bedroom count, bathroom count, finished square feet, lot size, number of stories, year built, location (e.g., county ID, GPS coordinates, etc.), transaction date, prior sale information (e.g., prior sale count), property description, and/or images or video data of the property. The property features can also include actual values of the property (e.g., sale price, listing price, market price, bidding price), the regional historical certainty of the property (e.g., regional historical error, standard deviation, the standard error in the price or market of properties in the region that the particular property is located in), lot features, land property features, and/or commercial property features. The property features can further include how special the property is in its county or geographic location, such as, the land size or square footage difference from other properties, tax difference from neighboring or comparable properties, tax history (e.g., tax difference between different years or seasons, tax change after last sell of the property), age difference from neighboring or comparable properties, remodeling information, new construction information, and/or feature changes.

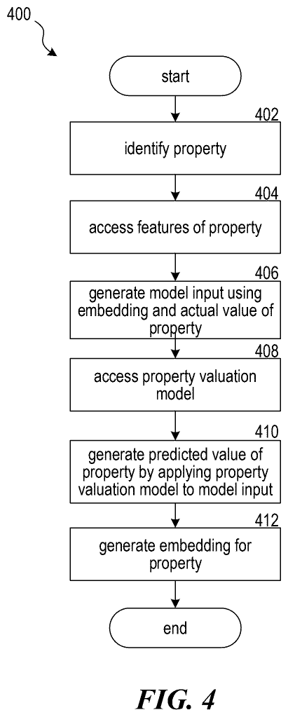

The heuristic filter 262 can identify an initial set of candidate comparable properties for a property. In some implementations, the heuristic filter 262 can first obtain an entire set of properties associated with the property data stored in property data store 302. The heuristic filter 262 can then filter the entire set of properties to identify a set of candidate comparable properties that a set of heuristic criteria, which may be defined as a measure of distance, time since sale, and/or of physical characteristics (e.g., home type, number of stories, etc.). The heuristic criteria can be used to subset properties based on a threshold value or by a minimum count. For example, the heuristic filter 262 can filter the entire set of properties to identify only those properties that are within a predefined distance of, in the same ZIP code as, or in a same region (e.g., similar rent) as the property. In some implementations, the heuristic filter 262 can also filter the entire set of properties to identify candidate comparable properties that were sold within a predefined time range. For example, the heuristic filter 262 can select only candidate comparable properties that are sold within 1 year of the present time period or within 6 months that the property was sold. In some implementations, the heuristic filter can also select properties based on characteristics, for example only candidate comparable properties that share the same number of stories. In some implementations, the heuristic filter can be temporal or character-based criteria. In various implementations, the heuristic filter 262 can further limit the number of candidate comparable properties selected to a predefined amount. For example, the heuristic filter 262 can limit the maximum of candidate comparable properties for the property to be 10. The heuristic filter 262 can store the set of candidate comparable properties determined for the property in the property data store 302. More details regarding heuristic filtering are described below in relation to FIGS. 4-6.

The property valuation model 264 can be one or more machine learning or statistical models (e.g., automated valuation models) trained to generate predicted values of properties (e.g., the predicted value is generated by one of the automated valuation models, generated by an ensemble of the one or more automated valuation model, or generated by synthesizing the predicted values from the one or more automated valuation models via a mean, median, weighted mean, or weighted median). The property valuation model 264 can generate predicted values for a particular property and also the candidate comparable properties thereof. For instance, the property valuation model 264 can generate predicted values for a property and the comparable properties thereof. The predicted values of such properties can be stored in the property data store 302. The following applications, each of which is hereby incorporated by reference in its entirety, describe examples of models that can be employed (e.g., property valuation models used to generate predicted values of properties): U.S. patent application Ser. No. 17/536,929 filed on Nov. 29, 2021, U.S. patent application Ser. No. 17/322,208 filed on May 17, 2021, U.S. patent application Ser. No. 16/951,900 filed on Nov. 18, 2020, U.S. patent application Ser. No. 11/971,758 (now U.S. Pat. No. 8,140,421) filed on Jan. 9, 2008, U.S. patent application Ser. No. 11/347,000 (now U.S. Pat. No. 8,676,680) filed on Feb. 3, 2006, U.S. patent application Ser. No. 11/347,024 (now U.S. Pat. No. 7,970,674) filed on Feb. 3, 2006, U.S. patent application Ser. No. 11/524,047 (now U.S. Patent Publication No. 2008/0077458) filed on Sep. 19, 2006, U.S. patent application Ser. No. 11/524,048 (now U.S. Pat. No. 8,515,839) filed on Sep. 19, 2006, U.S. patent application Ser. No. 11/971,758 (now U.S. Pat. No. 8,140,421) filed on Jan. 9, 2008, U.S. patent application Ser. No. 13/797,363 (now U.S. Pat. No. 9,361,583) filed on Mar. 12, 2013, U.S. patent application Ser. No. 13/828,680 filed on Mar. 14, 2013, U.S. patent application Ser. No. 14/078,076 (now U.S. Pat. No. 10,754,884) filed on Nov. 12, 2013, and U.S. patent application Ser. No. 14/325,094 filed on Jul. 7, 2014. In some implementations, the property valuation models can comprise the one or more machine learning models described in relation to FIG. 2.

The embedding generator 266 can generate embeddings for properties (e.g., a particular property embedding, a subject property embedding, a candidate comparable property embedding). The embedding for a property can be a representation of the property in feature space (or in some cases, the latent or conceptual space of the property). In some implementations, the embedding can be a vector of raw numerical features, log numerical features, geospatial values, time series values, spatial maps, categorical values (e.g., one-hot encoding), and/or a combination thereof that the embedding generator 266 generates using the property data stored in the property data store 302. In other words, the embedding can be a mapping of variables to a vector of continuous numbers (e.g., via a single layer of a neural network or a hand-engineered vector of features). For example, the embedding can be a vector of the prior sale count, the latitude/longitude, list of tax values, and bathroom count of a subject property or a candidate comparable property thereof. Categorical values or variables can be the property features described above taking on a limited or fixed number of possible values (i.e., assigning a property feature to a particular group or nominal category). Examples of property features that can be represented as categorical values or variables: transaction month (e.g., possible months that the categorical value can take on: January, February, . . . . December), bedroom count (e.g., possible numbers that the categorical value can take on: 1, 1.5, 2, 2.5, . . . , 5), or region ID (e.g., possible IDs that the categorical value can take on: 1, 2, . . . , 1000), etc.

In various implementations, the embedding vector for a property can be a concatenation of individual vectors for a property, including a raw numerical vector, a learned vector, and/or a one-hot encoded vector. For example, when a neural network and is used to predict an output for a property (e.g., when the property valuation model 264 is a neural network used to generate a predicted value of the property), the embedding generator 266 can extract one of the layers of the neural network (e.g., the input layer, a hidden layer) as a learned individual vector for the property. When the comps processing system 300 only uses the learned individual vector in generating embeddings, the learned individual vector can be the embedding for the property. When the comps processing system 300 uses the learned individual vector with other individual vectors in generating embeddings, the embedding generator 266 can also concatenate the learned individual vector with a raw numerical individual vector and/or one-hot encoded individual vector of the property to be the embedding for the property.

Since the embedding vector is a representation of a property in feature space, properties with similar embedding vectors can have more similar features as one-another. In some implementations, the similarity between two embedding vectors (used herein as “embedding similarity”) can be measured as the difference between the two embedding vectors (e.g., a feature wise difference). The difference can be computed, e.g., by subtracting one embedding vector with the other embedding vector of the two embedding vectors. In some implementations, when the difference is an absolute difference, an absolute value of the subtraction between the two embedding vectors can be further computed to determine the embedding similarity. Embedding vectors with greater similarity may have smaller differences, indicating that their embedding vectors are closer to one-another in features space. Embedding vectors with less similarity may have larger differences, indicating that their embedding vectors are further from one-another in feature space. For example, a subject property with a similar square footage to a candidate comparable property will have a smaller difference for the square footage feature in the embedding vectors of the two properties. Due to embedding vectors being multi-dimensional, the comps processing system, 300 may summarize the difference between embedding vectors with a single output value for using in ranking candidate comparable properties that the embedding vectors correspond to. In some implementations, the comps processing system can compute, e.g., the sum of each component of the vector produced from computing difference between an embedding vector of a subject property and an embedding vector of a candidate comparable property. The sum can represent a similarity score between the subject property and the candidate comparable property.

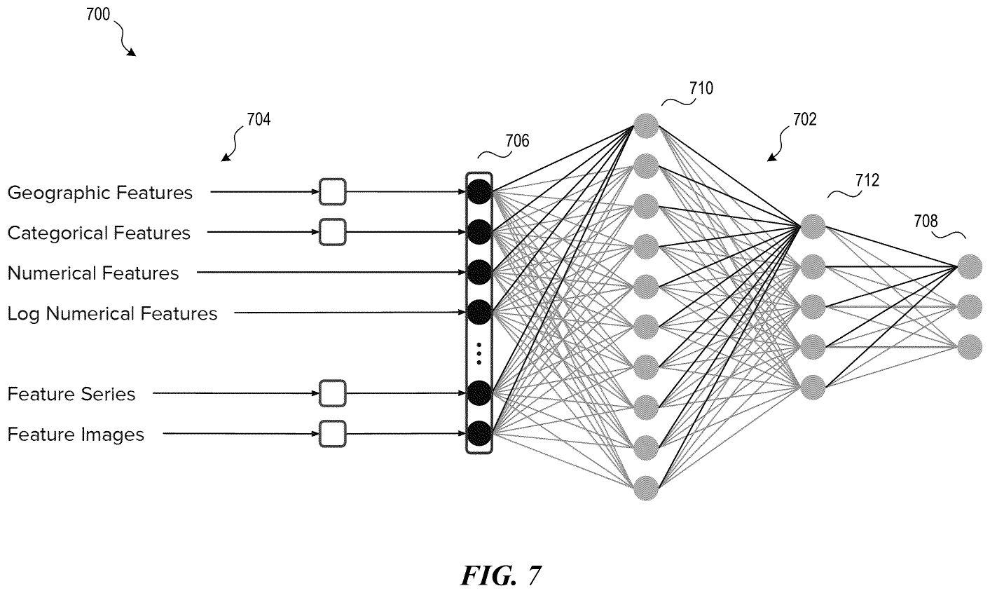

The embedding generator 266 can generate embeddings for any particular property, subject property, and/or candidate comparable property. The embedding generator 266 can store the generated embeddings in the property data store 302, each labeled with the property that the embedding pertains to. More details on embedding generation are described in relation to FIGS. 4 and 7 below.

Using the embeddings, actual values, and predicted values for particular properties and candidate comparable properties thereof as model inputs, the comps processing system 300 can train the implicit comparable-ranking model 268 to produce a predicted value for a subject property and intermediate outputs. The produced intermediate outputs can include a compatibility probability (i.e., embedding similarity score) representing a degree of similarity between a candidate comparable property and a subject property. When n-number of embeddings of candidate comparable properties are used as model inputs, the implicit comparable-ranking model 268 can generate n-number of compatibility probabilities, each representing the degree of similarity between each candidate comparable property and the subject property. To generate the compatibility probability for each of the n-number of candidate comparable properties, the implicit comparable-ranking model 268 can first compute the difference between the embedding of the candidate comparable property and the embedding of the subject property. Since the implicit comparable-ranking model 268 can be a neural network, the implicit comparable-ranking model 268 can include a node with a corresponding set of weights/parameters. The node can take as input the difference between the embeddings of the candidate comparable property and the subject property, and output a compatibility probability (e.g., via weighting the difference vector with the weight/parameters of the node). Accordingly, the implicit comparable-ranking model 268 can compute a compatibility probability for each of the n-number of candidate comparable properties.

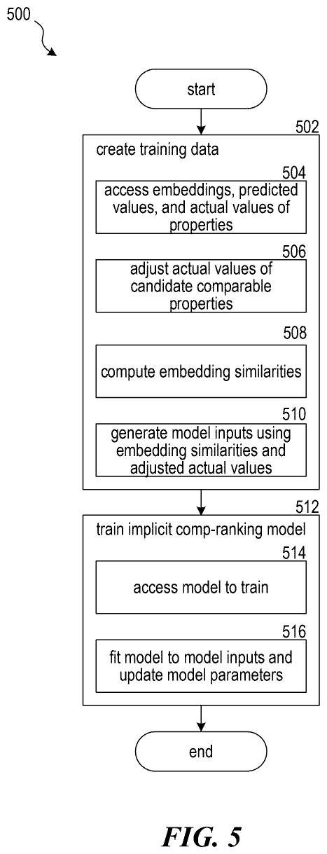

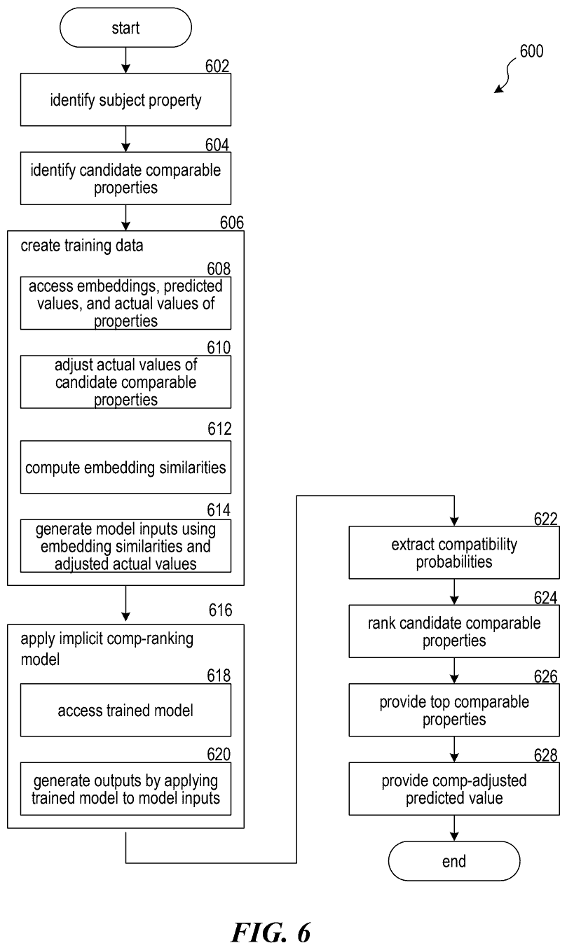

The compatibility probabilities, though, form intermediate outputs of the implicit comparable-ranking model 268, meaning that they can be outputted values at one of the hidden neural network layers of the implicit comparable-ranking model 268 that are subsequently used to generate the final outputs of the model. In particular, the implicit comparable-ranking model 268 can subsequently weigh an adjusted actual value of each candidate comparable property using the associated compatibility probability of the candidate comparable property. The adjusted actual value can be an adjustment of the actual value of a candidate comparable property using the predicted value of the candidate comparable property. Upon weighting the adjusted values of the candidate comparable properties, the implicit comparable-ranking model 268 can synthesize the weighted adjusted values (e.g., computing a sum, median, mean, average, etc.) to produce the final output, which is a comparable-adjusted predicted value of the subject property. The comparable-adjusted predicted value of the particular property can represent a predicted value of the property upon considering the values of candidate comparable properties and how similar they are to the subject property based on the compatibility probabilities. In some implementations, the implicit comparable-ranking model 268 can subsequently provide the comparable-adjusted predicted value of the subject property to a user device 314 (e.g., the device of a buyer or seller of a property). In various implementations, the implicit comparable-ranking model 268 can use the implicitly generated compatibility probabilities for a subject property to rank the candidate comparable properties. Candidate comparable properties with higher compatibility probabilities can be ranked higher and identified as top comparable properties to provide to the user device 314. For example, candidate comparable properties with compatibility probabilities greater than a predefined threshold or within a range of predefined threshold values can be identifies as top comparable properties to provide to the user device 314. The implicit comparable-ranking model 268 can also store the compatibility probabilities labeled with the associated candidate comparable properties in the property data store 302, and the comparable-adjusted predicted value of the subject property in the property data store 302. More details on the process performed by the implicit comparable-ranking model 268 are described below in relation to FIGS. 5-6.

FIG. 4 is a flow diagram illustrating a process 400 of generating embeddings and predicted values of properties in accordance with some implementations of the present technology. At act 402, process 400 identifies a property. The property can be any particular property, subject property, or candidate comparable property thereof. At act 404, process 400 accesses features of the property. In particular, process 400 can access a property data store to obtain the property features. In some implementations, the property data store can be the property data store 302 described in relation to FIG. 3. As an example, process 400 can access property data records, labeled with the first particular property, that describe property features such as: 3 bedrooms, 1500 square feet, 2 bathrooms, 2 garage spaces, modern style, and Seattle zip code. More details on other examples of property data and features that can be accessed for the property are described in relation to the property data store 302.

At act 406, process 400 generates model inputs, to be used by a property valuation model at act 410, using the accessed property features and an actual value of the property. In particular, process 400 can generate/create a model input using the features of the property and an actual value of the property accessed from the property data store 302. In some implementations, process 400 can first generate/create a feature vector (e.g., actual data, encoding, embedding) to represent the property's set of features. The feature vector can be a concatenation of one or more raw numerical vectors, one-hot encoded vectors, and/or learned individual embedding vectors that represent the property's features. An example of a feature vector is described below in relation to FIG. 7. Process 400 can then generate the model input for the property as a tuple of the property's feature vector and the actual value of the property (i.e., the ground truth value). For example, the model input for the property can be {[properties' feature vector], $100,000}. In some implementations, the feature vector can be the embedding vector or a part of the embedding vector (e.g., the feature vector concatenated with other vectors). More details on the types of individual vectors and features an embedding can be comprised of are described in relation to the embedding generator 266 of FIG. 3.

At act 408, process 400 accesses a property valuation model. More specifically, the property valuation model can be any automated valuation model trained to generated predicted values of properties. In some implementations, the property valuation model can be the property valuation model 264 and can be trained according to any of the model training approaches described in relation to FIGS. 2-3. At act 410, process 400 generates a predicted value of the property by applying the accessed property valuation model to the model input. The property valuation model can input the model inputs and generate/output a predicted value of the property. In various implementations, process 400 can provide the generated predicted value of the property to act 504 of process 500 in FIG. 5 or store the generated predicted value of the property in the property data store 302 so that process 500 can access, at act 504, the embedding from the property data store 302. Process 400 can also provide the generated predicted value of the property to act 608 of process 600 in FIG. 6 or store the generated predicted value of the property in the property data store 302 so that process 600 can access, at act 608, the predicted value of the property from the property data store 302.

At act 412, process 400 generates an embedding for the property. In some implementations, the generated embedding vector can be the feature vector that is used to generated model inputs for the property valuation model at act 406. In other words, process 400 can generate the embedding for the property by extracting the input neural network layer of the trained property valuation model to be the embedding vector. In various implementations, the generated embedding vector can be any hidden neural network layer of the property valuation model. More specifically, process 400 can generate the embedding for the property by extracting one of the hidden neural network layers of the property valuation model to be the embedding vector. For example, process 400 can extract the layer after the input layer as the embedding vector or the layer before the output layer as the embedding vector. An example of an embedding vector is described below in relation to FIG. 7.

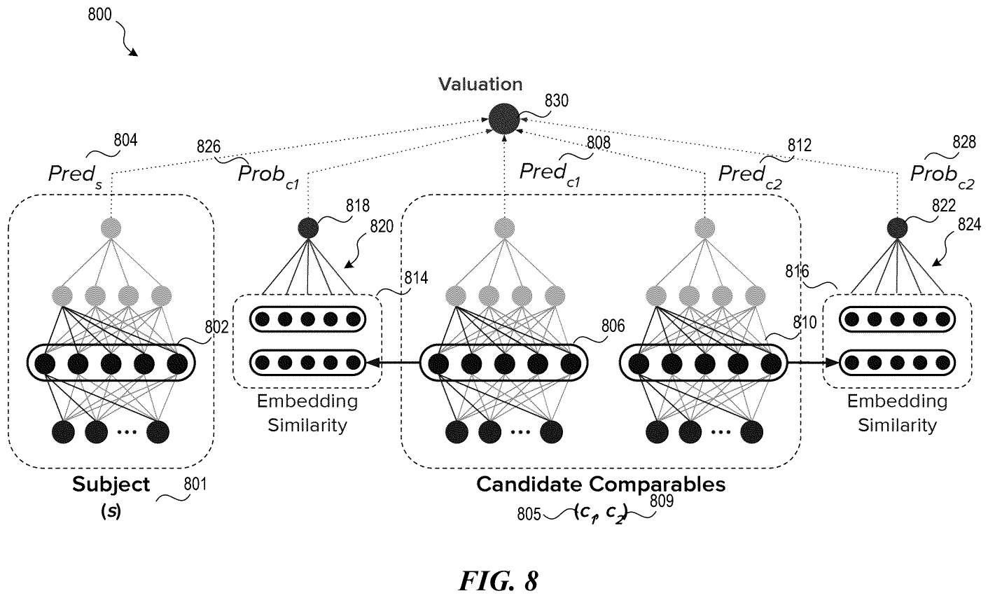

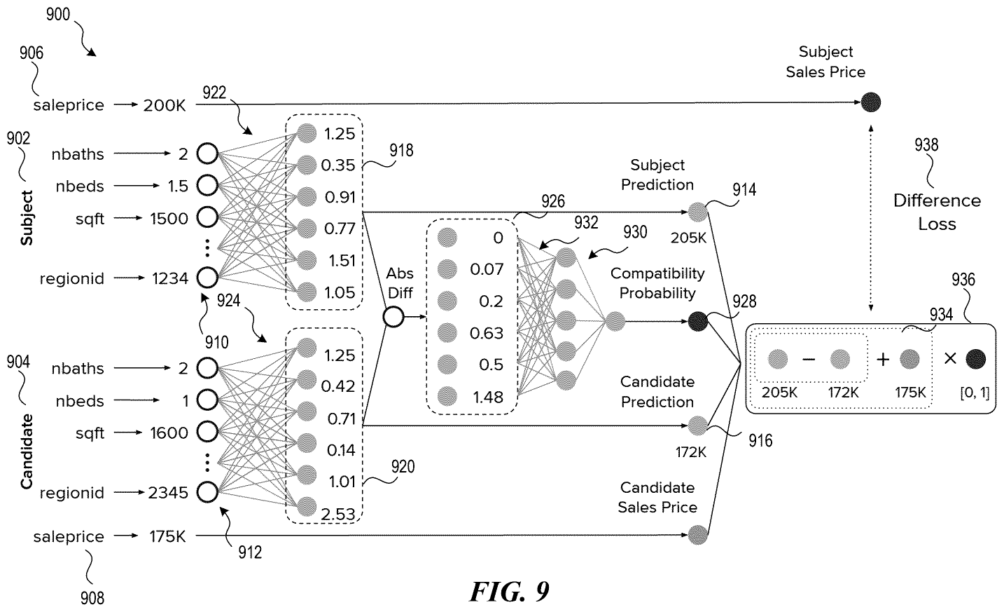

FIG. 5 is a flow diagram illustrating a process 500 of training an implicit comparable-ranking model in accordance with some implementations of the present technology. At act 502, process 500 creates training data. Process 500 can first identify a set of properties. The set of properties can be the properties associated with the property data stored in the property data store 302 in FIG. 3 (e.g., the property labels of associated with the property data). Upon identifying a set of properties, process 500 can access a set of candidate comparable properties for each particular property in the set of properties. In some implementations, the heuristic filter 262 can identify the set of candidate comparable properties for each particular property in the set of properties. For example, the heuristic filter 262 can identify properties that are in the same geographic region as that of the particular property to be the candidate comparable properties. Process 500 can subsequently access the identified set of candidate comparable properties for each particular property. As an example, process 500 can identify the following set of properties and candidate comparable properties thereof: {(property 1, candidate comp property 1 of property 1, candidate comp 2 of property 1, . . . candidate comp n of property 1), (property 2, candidate comp 1 of property 2, candidate comp 2 of property 2, . . . candidate comp n of property 2), . . . (property x, candidate comp 1 of property x, candidate comp 2 of property x, . . . candidate comp n of property x)}. The number of candidate comparable properties that process 500 accesses for each particular property can depend on the number of candidate comparable properties that the implicit comparable-ranking model, to be trained at act 510, can take as inputs. In some implementations, the implicit comparable-ranking model can take at least one candidate comparable property as input (e.g., 2 candidate comparable properties, n candidate comparable properties). FIGS. 8-9, which are described in more detail below, show an example of an implicit comparable-ranking model that can take 2 candidate comparable properties as inputs.

At act 504, process 500 accesses embeddings, predicted values, and actual values of the set of properties and candidate comparable properties thereof. In particular, process 500 can access an embedding, a predicted value, and an actual value for each particular property in the set of properties. Process 500 can also access an embedding, a predicted value, and an actual value for each candidate comparable property in the set of candidate comparable properties accessed for each particular property. In some implementations, the embeddings for the particular property and candidate comparable properties can be generated by process 400 at act 412 and stored in the property data store 302. Process 500 may then access the embeddings, predicted values, and the actual values for the particular properties and candidate comparable properties generated by the embedding generator from the property data store 302.

At act 506, process 500 adjusts the actual values of the candidate comparable properties. In particular, process 500 can adjust the actual value for each candidate comparable property in the set of candidate comparable properties accessed for each particular property according to the following computations: (1) compute a difference between the predicted value of the particular property and the predicted value of the candidate comparable property, and (2) compute a sum between the computed difference and the actual value of the candidate comparable property. In some implementations, the computations for adjusting the actual value for each candidate comparable property can be represented by the following formula:

$$adjusted {value}_{comp} = ( predicted {value}_{home} - predicted {value}_{comp} ) + actual {value}_{comp}$$

The adjusted actual value of each candidate comparable property can represent an estimated value of the associated particular property based on considering the candidate comparable property. In theory, if the candidate comparable property has the same actual value as the associated particular property, then the difference between the predicted values of the particular property and candidate comparable property thereof is 0.

At act 508, process 500 computes embedding similarities between the set of properties and the candidate comparable properties thereof. For each candidate comparable property in the set of candidate comparable properties accessed for each particular property, process 500 can compute an embedding similarity between the candidate comparable property and the particular property using the embedding of the candidate comparable property and the embedding of the particular property. More specifically, process 500 can compute a difference between the embedding of the candidate comparable property and the embedding of the particular property as the embedding similarity (e.g., subtract the embedding vector of the candidate comparable property from the embedding vector of the particular property, or vice versa). In some implementations, the difference can be an absolute difference between the embedding vectors of the candidate comparable property and the particular property (e.g., computing an absolute value of the subtraction between the embedding vectors of the candidate comparable property and the particular property). By computing the element-wise difference between the embedding vectors, process 500 can determine how similar the features of the candidate comparable property and the particular property are. A greater difference can signify less similarity with respect to that embedding element, while a smaller difference can signify greater similarity with respect to that embedding element between the particular property and the candidate comparable property thereof.

At act 510, process 500 generates model inputs using (1) the computed embedding similarities, and (2) the adjusted actual values of the candidate comparable properties. In particular, process 500 can generate/create model inputs using the computed embedding similarities and adjusted actual values for each candidate comparable property in the set of candidate comparable properties accessed for each particular property. In some implementations, process 500 can first generate/create a feature vector (e.g., raw/actual data, encoding, embedding, or any other approaches described herein to generate a vectorized representation) to represent each candidate comparable property's embedding similarity and adjusted actual value. Process 500 can then generate the model input for each candidate comparable property's feature vector and the ground-truth actual value for the associated particular property (e.g., tuples of the form {feature vector, actual value of particular property}). For example, the model input for the first candidate comparable property for the first particular property can be: {[candidate comp 1's feature vector], $700,000}.

At act 512, process 500 trains the implicit comparable-ranking model using the model inputs generated at act 510. The ground-truth actual values of the model inputs can be the error or uncertainty that the implicit comparable-ranking model learns to fit or produce based on the inputted feature vectors of the model inputs. Accordingly, process 500 can learn to predict actual values of properties by identifying patterns or trends in the property data and/or the model data in relation the ground-truth actual values. At act 514, process 500 can access/obtain an implicit comparable-ranking model (e.g., model 268) to train. In various implementations, the implicit comparable-ranking model can be a neural network (e.g., Siamese network) that includes one or more nodes/neurons each with a corresponding set of weights, biases, or parameters. The nodes can make up the layers of the neural network. The number of nodes in the implicit comparable-ranking model can be at least the number of candidate comparable properties that the implicit comparable-ranking model uses as inputs. For instance, the implicit comparable-ranking model can include at least 2 nodes, and each of these nodes can take the generated embedding similarity for each candidate comparable property and output a single compatibility probability using the set of weights/parameters (e.g., computing a dot product between the embedding similarity vector and the set of weights/parameters).

Upon generating the compatibility probability for each candidate comparable property of the particular property, the implicit comparable-ranking model can weight the predicted value of the candidate comparable property with its corresponding compatibility probability. In particular, the implicit comparable-ranking model can compute a product between the adjusted actual value of each candidate comparable property and its compatibility probability. Since the compatibility probability represents a degree of similarity between the associated candidate comparable property and the corresponding particular property, candidate comparable properties with greater compatibility probabilities may have their predicted values weighted higher. Moreover, because the computability probabilities are generated by nodes of a hidden layer of the implicit comparable-ranking model, they form intermediate outputs of the model, and not the final output (i.e., the predicted value that the model learns). Accordingly, the implicit comparable-ranking model implicitly learns to generate the compatibility probabilities, as it learns holistically to predict the actual value of a particular property. In some instances, the implicit comparable-ranking model can provide the generated compatibility probabilities to process 600 at act 620 of FIG. 6 to subsequently use in ranking the candidate comparable properties.

The implicit comparable-ranking model can further include a synthetization node that synthesizes the generated compatibility probabilities. The synthetization node can synthesize the weighted adjusted values of the candidate comparable properties to produce a comparable-adjusted predicted value of the particular property. The comparable-adjusted predicted value of the particular property can represent a revised estimate of the predicted value of the particular property when factoring in the candidate comparable properties and their measures of similarity to the particular property. In some implementations, the synthetization node can perform the synthetization by computing a sum of the weighted adjusted values of the candidate comparable properties. In various implementations, the synthetization node can perform the synthetization by selecting a largest weighted adjusted value amongst the weighted adjusted values of the candidate comparable properties. In further implementations, the synthetization node can perform the synthetization by computing a median or other central tendency of the weighted adjusted values of the candidate comparable properties. Examples of the structure of the implicit comparable-ranking model and the nodes thereof are described in relation to FIGS. 8-9 below.

At act 516, process 500 fits the implicit comparable-ranking model to the generated model inputs and updates model parameters as the model is fitted. The model parameters can include, e.g., weights, parameters, biases, constants, and/or hyperparameters of the implicit comparable-ranking model. In some implementations, process 500 can train and fit the implicit comparable-ranking model using any of the methodologies used to train or test of the one or more machine learning models described in relation to FIG. 2. For instance, process 500 can fit the implicit comparable-ranking model such that it minimizes some loss function that outputs a loss between the comparable-adjusted predicted value of each particular property and the accessed predicted value of the particular property. More specifically, process 500 can compute a loss value for each particular property by applying a loss function to the comparable-adjusted predicted value and the actual value of the particular property. Process 500 can subsequently update one or more parameters of the implicit comparable-ranking model based on the computed loss value (e.g., apply gradient descent and adjust the weights of the model to minimize the loss). In various implementations, process 500 can provide the implicit comparable-ranking model, trained to produce comparable-adjusted predicted values and intermediate outputs, to process 600 at act 614.

FIG. 6 is a flow diagram illustrating a process 600 of implicitly ranking comparable properties in accordance with some implementations of the present technology. In some implementations, process 600 can be triggered upon receiving requests, transmitted from one or more user devices, to estimate the value of a subject property from the comps processing system (e.g., seller clicks on a GUI button of the property display page to get a predicted value for their property) or to receive the top comparable properties the subject property. In some implementations, process 600 can be triggered at any instance when there are subject properties to determine comparable properties for or when an automated valuation model has completed valuation of a subject property. In various implementations, process 600 can be triggered upon completion of process 500 of FIG. 5.

At act 602, process 600 identifies a subject property to determine comparable properties and/or a predicted value for. At act 604, process 600 identifies a set of candidate comparable properties. In some implementations, process 600 can identify the set of candidate comparable properties using similar ways as those described in process 500 at act 502 and the heuristic filter 262 in FIG. 3.

At act 606, process 600 prepares data for an implicit comparable-ranking model to be applied to at act 614. At act 608, process 600 accesses embeddings, actual values, and predicted values for the identified subject property and the identified set of candidate comparable properties thereof. In particular, process 600 can access an embedding, a predicted value, and an actual value for the subject property. Process 600 can also access the embedding, a predicted value, and an actual value for each candidate comparable property in the set of candidate comparable properties identified for the subject property. In some implementations, the embeddings for the subject property and candidate comparable properties thereof can be generated by process 400 at act 412 and stored in the property data store 302. Process 600 may then access the embeddings, predicted values, and the actual values for the particular properties and candidate comparable properties generated by the embedding generator from the property data store 302.

At act 610, process 600 adjusts the actual values of the candidate comparable properties. In particular, process 600 can adjust the actual value for each candidate comparable property in the set of candidate comparable properties accessed for each particular property according to any of the computations described in relation to act 506 of process 500.

At act 612, process 600 computes embedding similarities between the subject property and the candidate comparable properties thereof. For each candidate comparable property in the set of candidate comparable properties identified for the subject property, process 600 can compute an embedding similarity between the candidate comparable property and the embedding of the particular property. Accordingly, process 600 generates an embedding similarity for each candidate comparable property. To do so, process 600 can use any of the computations described in relation to act 508 of process 500.

At act 614, process 600 generates model inputs using (1) the computed embedding similarities, and (2) the adjusted actual values of the candidate comparable properties. In particular, process 600 can generate/create one or more model inputs using the computed embedding similarities and adjusted actual values for each candidate comparable property in the identified set of candidate comparable properties. In various implementations, process 600 can generate the one or more model inputs using any of the approaches described in relation to act 510 of process 500. In some implementations, each of the one or more model inputs includes the subject property and a subset of the set of candidate comparable properties. The number of candidate comparable properties in the subset can correspond to the number of candidate comparable properties the implicit comparable-ranking model can take as input. For example, suppose there are 4 candidate comparable properties for the subject property and the number of candidate comparable properties the implicit comparable-ranking model can take as input is 2. In this scenario, process 600 can generate 2 model inputs for the following 2 groupings: {subject property, (candidate comparable property 1, candidate comparable property 2)} and {subject property, (candidate comparable property 3, candidate comparable property 4)}.

At act 616, process 600 applies an implicit comparable-ranking model to the generated model inputs. At act 618, process 600 accesses an implicit comparable-ranking model trained to produce a comparable-adjusted predicted value and intermediate outputs. In some implementations, process 600 can access the trained implicit comparable-ranking model from act 512 of process 500. At act 620, process 600 generates a comparable-adjusted predicted value and intermediate outputs by applying the implicit comparable-ranking model, trained to produce comparable-adjusted predicted values and intermediate outputs, to the one or more generated model inputs. In some implementations, process 600 can apply the implicit comparable-ranking model to each of the generated one or more model inputs. As mentioned previously, each of the one or more model inputs can be associated with a subject property and a subset of the identified set of candidate comparable properties for the subject property. For each candidate comparable property in each of the subsets, process 600 can generate, using the embedding similarity associated with the candidate comparable property and one or more parameters of the model, the compatibility probability associated with the candidate comparable properties. The one or more parameters can be a node with a corresponding set of weights, biases, or parameters. For each candidate comparable property in each of the subsets, process 600 can further generate, using the adjusted actual value of the candidate comparable property and the compatibility probability associated with the candidate comparable property, a weighted adjusted value of the candidate comparable property. More details on generation of compatibility probabilities and weighted adjusted values are described in relation to act 512 of process 500.

Continuing with the example above, process 600 can apply the implicit comparable-ranking model to the first grouping {subject property, (candidate comparable property 1, candidate comparable property 2)} and then to the second grouping {subject property, (candidate comparable property 3, candidate comparable property 4)}. Accordingly, process 600 can generate a first comparable-adjusted predicted value and intermediate outputs using the first grouping and a second comparable-adjusted predicted value and intermediate outputs using the second grouping. In other words, the implicit comparable-ranking model can input each of the one or more model inputs and generate/output a predicted value and intermediate outputs for the subject property in each of the one or more model inputs.

At act 622, process 600 extracts, from the intermediate outputs of the implicit comparable-ranking model applied to the one or more generated model inputs, the compatibility probabilities associated with the identified candidate comparable properties. In particular, process 600 can extract the compatibility probabilities associated with the candidate comparable properties in each of the one or more generated model inputs. More details on the compatibility probabilities are described in relation to act 512 of process 500. Continuing with the example above, process 600 can extract a compatibility probability, from the applied model, for each of candidate comparable properties 1-4 in the first and second groupings.

At act 624, process 600 ranks the candidate comparable properties. In particular, process 600 can rank the candidate comparable properties according to their associated compatibility probabilities generated therefor. Process 600 can rank candidate comparable properties with greater compatibility probabilities higher and rank candidate comparable properties with smaller compatibility probabilities lower. At act 626, process 600 provides the top comparable properties. More specifically, process 600 can select a predefined number of candidate comparable properties ranked with the highest compatibility probabilities as the top comparable properties for the subject property. Accordingly, the compatibility probabilities, which are intermediate outputs of the implicit comparable-ranking model, provide an implicit ranking of the candidate comparable properties. In some implementations, process 600 can provide the top comparable properties by transmitting the top comparable properties to a user device and causing generation of, on a user-interface of the user device, a graphical representation of the top comparable properties determined for the subject property. The user device can correspond to that of a seller/buyer.

At act 628, process 600 provides a comparable-adjusted predicted value. For each subset of the set of identified candidate comparable properties, process 600 can generate a comparable-adjusted predicted value by synthesizing (e.g., computing a sum of) the weighted adjusted values of the subset of candidate comparable properties to produce the comparable-adjusted predicted value for the particular property. More details on how synthetization is performed are described in relation to act 512 of process 600. In some implementations, process 600 can provide the comparable-adjusted predicted values for each of the subsets or provide one of the comparable-adjusted predicted values (e.g., the one with candidate comparable properties containing the highest compatibility probabilities, any arbitrary one). In various implementations, process 600 first select the candidate comparable properties with the highest compatibility probabilities. The number of candidate comparable properties selected can be a predefined number of properties that have the highest ranked compatibility probabilities or all properties with a compatibility probability above a predefined threshold value. Process 600 can then aggregate the adjusted actual values of the candidate comparable properties by computing a mean, median, weighted mean, weighted median, mode, or other measure of central tendency of the adjusted actual values. In such implementations, process 600 can provide the aggregation as the comparable-adjusted predicted value for the subject property.

FIG. 7 is a conceptual diagram illustrating an example 700 of an embedding of a property in accordance with some implementations of the present technology. Example 700 can include a property valuation model 702 implemented as a neural network. The comps processing system can generate a feature vector 704 representing a property (e.g., particular property, subject property, candidate comparable property) that includes a concatenation of geographic features (e.g., longitude value, latitude value, county ID), categorical features (e.g., pool count, bathroom count, year built), numerical features (e.g., prior sale count), log numerical features (e.g., tax amount, tax value, prior sale price), feature series (e.g., a series of geospatial values, a time series of list of tax values, a time series of images of tax values), and feature images (e.g., image or video data of the property), each represented as a raw numerical vector, one-hot encoded vector, and/or a learned individual embedding vector. Other examples of features that can be used are described in relation to the property data store 302 and embedding generator 266 of FIG. 3. When the property valuation model is being trained, the comps processing system can train the model using the feature vector 704 to produce an output layer 708 that can correspond to the predicted value of the property. When the property valuation model is being deployed, the comps processing system can apply the model to the feature vector 704 and produce a predicted value of the property. In some implementations, to generate an embedding vector for the property, the comps processing system can extract the input layer 706 of the property valuation model 702 to be the embedding vector of the property. In various implementations, the comps processing system can extract the hidden layer 710 or hidden layer 712 of the property valuation model 702 to be the embedding vector of the property.

FIG. 8 is a conceptual diagram illustrating an example 800 of an implicit comparable-ranking model in accordance with some implementations of the present technology. Example 800 is an example implementation of the implicit comparable-ranking model 268. Example 800 takes as inputs (1) an embedding 802, a predicted value 804 of a subject property 801; (2) an embedding 806, a predicted value 808, and an actual value (unshown in FIG. 8) of a first candidate comparable property 805; and (3) an embedding 810, a predicted value 812, and an actual value (unshown in FIG. 8) of a second candidate comparable property 809. When example 800 is an implicit comparable-ranking model being trained, example 800 can further take as input the ground-truth actual value of the subject property 801.

To generate a compatibility probability 826 for the first candidate comparable property 805, example 800 first computes the embedding similarity 814 between the embedding 802 and the embedding 806. A node 818 then inputs the embedding similarity and outputs the compatibility probability 826 by computing a dot product between the embedding similarity (e.g., an embedding similarity vector) and the weights/parameters 820 (e.g., a weight vector with same number of elements as that of the embedding similarity vector). Similarly, example 800 can generate a compatibility probability 828 for the second candidate comparable property 809. Example 800 computes the embedding similarity 816 and a node 822 inputs the embedding similarity 816 to output the compatibility probability 828 using corresponding weights/parameters 824.

In some implementations, example 800 determines an adjusted actual value for each of the first 805 and second 809 candidate comparable properties using the predicted values 804, 808, and 812, as well as the actual values of the first 805 and second 809 candidate comparable properties. Example 800 then weights the adjusted actual value for the first candidate comparable property 805 by the compatibility probability 826 and the adjusted actual value for the second candidate comparable property 809 by the compatibility probability 826. A synthetization node 830 can synthesize (e.g., sum or filter to select the adjusted value associated higher compatibility probability) the weighted adjusted values for the first and second candidate comparable properties and output a comparable-adjusted predicted value or valuation for the subject property. When the example 800 is an implicit comparable-ranking model being trained, example 800 can compute a valuation loss between the comparable-adjusted predicted value and the actual value of the subject property.

FIG. 9 is a conceptual diagram illustrating an example 900 of the comps processing system learning an implicit ranking of candidate comparable properties in accordance with some implementations of the present technology. Example 900 is a walkthrough example of the comps processing system performing processes 400, 500, and/or 600 of FIGS. 4-6. For purposes of example, example 900 only shows only a single candidate comparable property being identified. Though as mentioned above, the implicit comparable-ranking model can handle one or more candidate comparable properties (e.g., 2, 3, . . . n candidate comparable properties). Example 900 first identifies a subject property 902 and a candidate comparable property 904, and actual values 906 and 908 thereof, respectively. Example 900 then generates a predicted value 914 for the subject property 902 by applying a property valuation model to the feature vector 910 (e.g., [2, 1.5, 1500, . . . , 1234]). Example 900 also generates a predicted value 916 for the candidate comparable property 904 by applying the property valuation model to the feature vector 912 (e.g., [2, 1, 1600, . . . 2345]).

To generate an embedding vector 918 for the subject property 902, example 900 extracts one of the layers of the property valuation model when applied to the feature vector 910. The extracted layer can be the input/first layer or any of the hidden layers upon applying a set of weights to a previous layer (e.g., a second layer upon applying weights to the input layer). For instance, example 900 can extract the outputs of the nodes of the second layer [1.25, 0.35, 0.91, 0.77, 1.51, 1.05] as the embedding vector 918 upon applying a set of weights 922 to the feature vector 910 (e.g., computing a dot product between the weights vector 922 and the feature vector 910). Similarly, example 900 generates an embedding vector 920 for the candidate comparable property 904 by extracting one of the layers of the property valuation model when applied to the feature vector 912. For instance, example 900 can extract the outputs of the nodes of the second layer [1.25, 0.42, 0.71, 0.14, 1.01, 2.53] as the embedding vector 918 upon applying a set of weights 924 to the feature vector 912 (e.g., computing a dot product between the weights vector 924 and the feature vector 912).

In some implementations, example 900 computes an embedding similarity 926 between the subject property 902 and the candidate comparable property 904 by computing an absolute difference between the embeddings 918 and 920. For instance, example 900 can compute the element-wise difference between the embedding vectors [1.25, 0.35, 0.91, 0.77, 1.51, 1.05] and [1.25, 0.42, 0.71, 0.14, 1.01, 2.53] as the embedding similarity vector [0, 0.07, 0.2, 0.63, 0.5, 1.48]. Subsequently, example 900 generates a compatibility probability from the embedding similarity 926. To generate the compatibility probability, example 900 can input the embedding similarity 926 to the implicit comparable-ranking model. One or more nodes 930 of the implicit comparable-ranking model can apply corresponding one or more weights/parameters 932 to the embedding similarity vector to generate the compatibility probability 928. Example 900 can then generate an adjusted value for the candidate comparable property 934 using the actual value 908 of the candidate comparable property, the predicted value 916 of the candidate comparable property, and the predicted value 914 of the subject property. For instance, example 900 can compute the difference between the predicted value of 205K for the subject property 902 and the predicted value of 172K for the candidate comparable property 904, and then sum that computed difference with the actual value of 175K for the candidate comparable property 904. Example 900 weights this adjusted value with the generated compatibility probability to generate a comparable-adjusted predicted value 936 of the subject property. For instance, example 900 can weight the adjusted value with a compatibility probability between the values 0 and 1. When the implicit comparable-ranking model of example 800 is being trained, example 800 can compute a valuation/difference loss 938 between the comparable-adjusted predicted value 936 and the actual value 906 of the subject property.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented in parallel, or may be performed at different times. Further, any specific numbers noted herein are only examples: alternative embodiments may employ differing values or ranges.

The teachings of the technology provided herein can be applied to other systems, not necessarily the system described above. The elements and acts of the various examples described above can be combined to provide further embodiments of the technology. Some alternative embodiments of the technology may include not only additional elements to those embodiments noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, specific terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112 (f) will begin with the words “means for,” but use of the term “for” in any other context is not intended to invoke treatment under 35 U.S.C. § 112 (f). Accordingly, the applicant reserves the right to pursue additional claims after filing this application to pursue such additional claim forms, in either this application or in a continuing application.

1. A system for processing embeddings of properties to improve comparable properties generation, the system comprising:
at least one processor;
at least one memory coupled to the at least one processor and storing instructions that, when executed by the at least one processor, perform operations comprising:
identifying a set of properties to be used in training an implicit comparable-ranking model;
for each particular property in the set of properties, accessing:
(1) an embedding of the particular property, an estimated price of the particular property, and an actual value of the particular property corresponding to a sale price of the particular property,
wherein the embedding of the particular property is a representation of the particular property in feature space; and
(2) a set of candidate comparable properties for the particular property;
for each candidate comparable property in the set of candidate comparable properties:
accessing an embedding of the candidate comparable property, an estimated price of the candidate comparable property, and an actual value of the candidate comparable property corresponding to a sale price of the candidate comparable property;
adjusting, using the estimated price of the particular property and the estimated price of the candidate comparable property, the actual value of the candidate comparable property; and
computing, using the embedding of the candidate comparable property and the embedding of the particular property, an embedding similarity between the candidate comparable property and the particular property;
training the implicit comparable-ranking model to produce comparable-adjusted estimated prices and intermediate outputs by:
generating model inputs comprising: (1) the computed embedding similarities; and (2) the adjusted actual values of the candidate comparable properties;
wherein the produced intermediate outputs include compatibility probabilities associated with the candidate comparable properties, and
wherein each compatibility probability represents a degree of similarity between the associated candidate comparable property and each particular property; and
fitting the implicit comparable-ranking model to the generated model inputs and updating parameters of the model by providing the generated model inputs as input to the implicit comparable-ranking model; and
providing the trained implicit comparable-ranking model to produce the comparable-adjusted estimated prices and/or intermediate outputs.

2. The system of claim 1, wherein the set of candidate comparable properties are in a same geographic region as that of the particular property.

3. The system of claim 1, wherein the operations further comprise:
accessing: (1) raw values, (2) a one-hot encoding, and/or (3) a learned embedding representing one or more features of the candidate comparable property; and
concatenating the raw values, one-hot encoding, and/or learned embedding to generate the embedding of the candidate comparable property.

4. The system of claim 3, wherein the one or more features include one or more of: raw numerical features, log numerical features, geospatial values, time series, text, spatial maps, and/or categorical values.

5. The system of claim 1, wherein the actual value of the candidate comparable property is a sale price, a listing price, a market price, or a bidding price.

6. The system of claim 1, wherein the estimated price of the candidate comparable property is generated by a property valuation model.

7. The system of claim 6, wherein the embedding of the candidate comparable property is an input layer or a hidden layer of the property valuation model.

8. The system of claim 1, wherein adjusting the actual value of the candidate comparable property comprises:
computing a difference between the estimated price of the particular property and the estimated price of the candidate comparable property; and
computing a sum between the computed difference and the actual value of the candidate comparable property.

9. The system of claim 1, wherein computing the embedding similarity comprises:
computing a difference between the embedding of the candidate comparable property and the embedding of the particular property.

10. The system of claim 9, wherein each model input of the generated model inputs is associated with each particular property and the set of candidate comparable properties accessed for the particular property, wherein training the implicit comparable-ranking model further comprises:
for each particular property associated with the model inputs:
for each candidate comparable property accessed for the particular property:
generating, using the embedding similarity associated with the candidate comparable property and one or more of the parameters of the model, the compatibility probability associated with the candidate comparable property; and
generating, using the adjusted actual value of the candidate comparable property and the compatibility probability associated with the candidate comparable property, a weighted adjusted value of the candidate comparable property;
synthesizing the weighted adjusted values of the candidate comparable properties to produce a comparable-adjusted estimated price for the particular property;
computing a loss value, for each particular property, by applying a loss function to the comparable-adjusted estimated price and the actual value of the particular property; and
updating the one or more parameters of the model based on the computed loss value.

11. The system of claim 10, wherein generating the weighted adjusted value of the candidate comparable property comprises:
computing a product between the adjusted actual value of the candidate comparable property and the compatibility probability associated with the candidate comparable property to produce the weighted adjusted value.

12. The system of claim 11, wherein synthesizing the weighted adjusted values comprises:
computing a sum of the weighted adjusted values of the candidate comparable properties.

13. The system of claim 11, wherein synthesizing the weighted adjusted values comprises:
selecting a largest weighted adjusted value amongst the weighted adjusted values of the candidate comparable properties.

14. A method for processing embeddings of properties to improve comparable property generation, the method comprising:
identifying a subject property to determine top comparable properties for using a trained implicit comparable-ranking model;
accessing an embedding of the subject property and an estimated price of the subject property,
wherein the embedding of the subject property is a representation of the subject property in feature space;
identifying a set of candidate comparable properties for the subject property;
for each candidate comparable property in the set of candidate comparable properties:
accessing an embedding of the candidate comparable property, an estimated price of the candidate comparable property, and an actual value of the candidate comparable property corresponding to a sale price of the candidate comparable property;
adjusting, using the estimated price of the identified subject property and the estimated price of the candidate comparable property, the actual value of the candidate comparable property; and
computing, using the embedding of the candidate comparable property and the embedding of the subject property, an embedding similarity between the candidate comparable property and the subject property;
generating one or more model inputs comprising: (1) the computed embedding similarities; and (2) the adjusted actual values of the candidate comparable properties;
applying the implicit comparable-ranking model, trained to produce comparable-adjusted estimated prices and intermediate outputs, to the generated one or more model inputs by providing the generated model inputs as input to the implicit comparable-ranking model;
extracting, from the intermediate outputs of the applied model, compatibility probabilities associated with the candidate comparable properties; and
providing the candidate comparable properties with highest compatibility probabilities as the top comparable properties for the subject property.

15. The method of claim 14, wherein each of the one or more model inputs is associated with the subject property and a subset of the identified set of candidate comparable properties for the subject property.

16. The method of claim 15, wherein applying the implicit comparable-ranking model comprises:
for each subset of the identified set of candidate comparable properties:
for each candidate comparable property in the subset of candidate comparable properties:
generating, using the embedding similarity associated with the candidate comparable property and one or more parameters of the model, the compatibility probability associated with the candidate comparable property; and
generating, using the adjusted actual value of the candidate comparable property and the compatibility probability associated with the candidate comparable property, a weighted adjusted value of the candidate comparable property.

17. The method of claim 16, further comprising:
generating a comparable-adjusted estimated price of the subject property by:
synthesizing the weighted adjusted values of the subset of candidate comparable properties to produce the comparable-adjusted estimated price for the subject property; and
providing the comparable-adjusted estimated price of the subject property.

18. The method of claim 16, further comprising:
synthesizing the weighted adjusted values of the set of candidate comparable properties to produce the comparable-adjusted estimated price for the subject property; and
providing the comparable-adjusted estimated price of the subject property.

19. The method of claim 14, wherein providing the top comparable properties comprises:
selecting at least a predefined number of properties with highest compatibility probabilities as the top comparable properties for the subject property.

20. At least one non-transitory, computer-readable medium carrying instructions, which when executed by at least one data processor, performs operations comprising:
identifying a subject property to determine top comparable properties for using a trained implicit comparable-ranking model;
accessing an embedding of the subject property and an estimated price of the subject property,
wherein the embedding of the subject property is a representation of the subject property in feature space;
identifying a set of candidate comparable properties for the subject property;
for each candidate comparable property in the set of candidate comparable properties:
accessing an embedding of the candidate comparable property, an estimated price of the candidate comparable property, and an actual value of the candidate comparable property corresponding to a sale price of the candidate comparable property;
adjusting, using the estimated price of the identified subject property and the estimated price of the candidate comparable property, the actual value of the candidate comparable property; and
computing, using the embedding of the candidate comparable property and the embedding of the subject property, an embedding similarity between the candidate comparable property and the subject property;
generating one or more model inputs comprising: (1) the computed embedding similarities; and (2) the adjusted actual values of the candidate comparable properties;
applying the implicit comparable-ranking model, trained to produce comparable-adjusted estimated prices and intermediate outputs, to the generated one or more model inputs by providing the generated model inputs as input to the implicit comparable-ranking model;
extracting, from the intermediate outputs of the applied model, compatibility probabilities associated with the candidate comparable properties; and
providing the candidate comparable properties with highest compatibility probabilities as the top comparable properties for the subject property.
